(19) United States
(12) Patent Application Publication
(10) Pub. No.: US 2023/0023637 A1
(43) Pub. Date: Jan. 26, 2023

(54) ANTIVIBRATION SOUND INSULATION DEVICE

(71) Applicant: MITSUBISHI HEAVY INDUSTRIES, LTD., Tokyo (JP)

(72) Inventors: Keizo Onishi, Tokyo (JP); Takanori Ito, Tokyo (JP); Yusuke Mizuno, Tokyo (JP); Noriyuki Takeda, Tokyo (JP)

(73) Assignee: MITSUBISHI HEAVY INDUSTRIES, LTD., Tokyo (JP)

(21) Appl. No.: 17/954,823

(22) Filed: Sep. 28, 2022

Related U.S. Application Data
(63) Continuation of application No. PCT/JP2021/013641, filed on Mar. 30, 2021.

(30) Foreign Application Priority Data
Mar. 30, 2020 (JP) 2020-061482

(51) Int. Cl. G10K 11/162

(52) U.S. Cl. CPC G10K 11/162

(57) ABSTRACT

This antivibration sound insulation device is provided with: an antivibration mechanism which is mounted on a stand and disposed close to a prescribed sound source at a plant; and sound-absorbing sound insulation walls which are supported by the antivibration mechanism and arranged so as to surround the sound source.

### CROSS-REFERENCE TO RELATED APPLICATION

This application is a continuation of PCT International Application No. PCT/JP2021/013641 filed on Mar. 30, 2021 which claims the benefit of priority from Japanese Patent Application No. 2020-061482 filed on Mar. 30, 2019, the entire contents of which are incorporated herein by reference.

### TECHNICAL FIELD

The present disclosure relates to an antivibration sound insulation device.

### BACKGROUND ART

A plant is provided with a soundproof structure that suppresses noise generated from a sound source of an apparatus. For example, as the soundproof structure, a structure that performs soundproofing treatment for surrounding the sound source itself, or a structure that installs a sound insulation wall for supporting antivibration at the plant is known (for example, refer to PTL 1).

### CITATION LIST

### Patent Literature

[PTL 1] Japanese Patent No. 3478766

### SUMMARY OF INVENTION

### Technical Problem

Although the soundproofing treatment for surrounding the sound source as described above achieves a high soundproofing effect, it is difficult to supplementarily install the structures after the plant is constructed. Therefore, for example, it is difficult to apply the structures when the noise of the sound source needs to be reduced a little more after the plant is constructed. In addition, the soundproofing treatment as disclosed in PTL 1 requires a large-scale configuration in which an antivibration mechanism and a soundproofing wall are directly installed on a floor part. The plant is provided with a stand for inspecting each unit. Therefore, in the soundproofing treatment disclosed in PTL 1, it is difficult to dispose the structures for a place where the stand is provided.

The present disclosure is made in view of the above-described circumstances, and an object of the present invention is to provide an antivibration sound insulation device which can be supplementarily installed after a plant is constructed and can also be disposed for a place where a stand is provided.

### Solution to Problem

According to the present disclosure, there is provided an antivibration sound insulation device including an antivibration mechanism attached to a stand disposed close to a predetermined sound source at a plant, and a sound absorbing sound insulation wall supported by the antivibration mechanism and disposed to surround the sound source.

### Advantageous Effects of Invention

According to the present disclosure, it is possible to provide an antivibration sound insulation device which can be supplementarily installed after a plant is constructed and can also be disposed for a place where a stand is provided.

### BRIEF DESCRIPTION OF DRAWINGS

FIG. 1 is a view (perspective view) illustrating an example of an antivibration sound insulation device according to a first embodiment.

FIG. 2 is a view (plan view) illustrating an example of the antivibration sound insulation device according to the first embodiment.

FIG. 3 is a view illustrating an example of an antivibration sound insulation device according to a second embodiment.

FIG. 4 is a view illustrating an antivibration sound insulation device according to a modification example.

FIG. 5 is a view illustrating an antivibration sound insulation device according to a modification example.

FIG. 6 is a view illustrating an example of an antivibration sound insulation device according to a third embodiment.

FIG. 7 is a view illustrating an example of an antivibration sound insulation device according to a fourth embodiment.

FIG. 8 is a view illustrating an example of an antivibration sound insulation device according to a fifth embodiment.

FIG. 9 is a view illustrating an antivibration sound insulation device according to a modification example.

FIG. 10 is a view illustrating an antivibration sound insulation device according to a modification example.

FIG. 11 is a view illustrating an antivibration sound insulation device according to a modification example.

FIG. 12 is a view illustrating an example of an antivibration sound insulation device according to a sixth embodiment.

FIG. 13 is a view illustrating an antivibration sound insulation device according to a modification example.

FIG. 14 is a view illustrating an antivibration sound insulation device according to a modification example.

### DESCRIPTION OF EMBODIMENTS

Hereinafter, embodiments of an antivibration sound insulation device according to the present disclosure will be described with reference to the drawings. The present invention is not limited by the embodiments. In addition, configuration elements in the following embodiments include those which can be easily replaced by those skilled in the art, or those which are substantially the same.

### First Embodiment

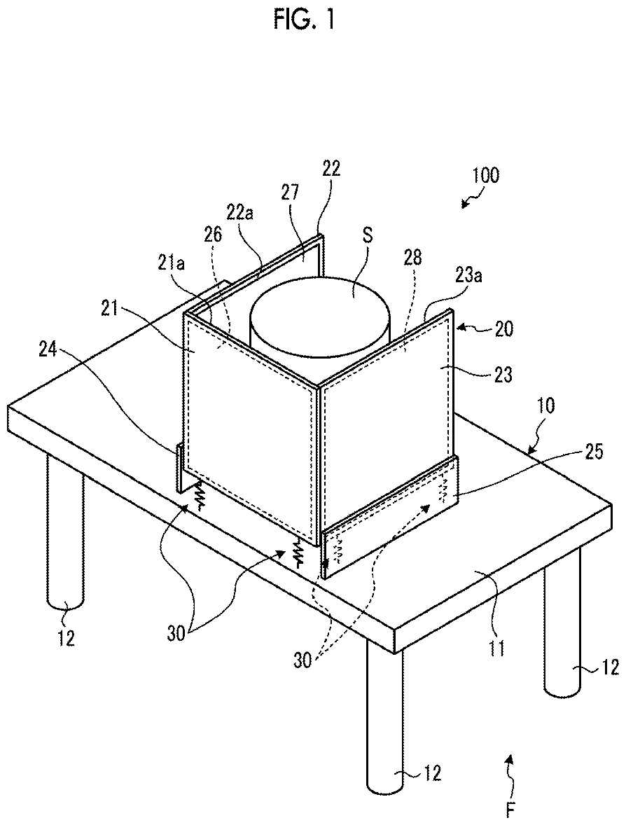

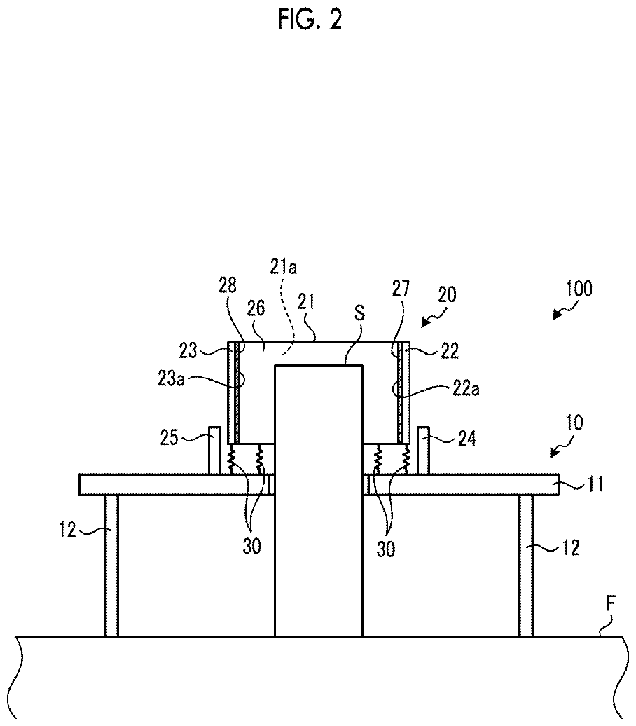

FIGS. 1 and 2 are views illustrating an example of an antivibration sound insulation device 100 according to a first embodiment. FIG. 1 is a perspective view, and FIG. 2 is a side view. As illustrated in FIGS. 1 and 2, the antivibration sound insulation device 100 is provided to suppress noise from a predetermined sound source S at a plant. In the present embodiment, for example, the plant includes a power plant having a steam turbine and a mechanical plant having various machines. The plant is provided with a stand 10 disposed close to the sound source S.

The stand 10 is supported by a floor surface F of the plant. The stand 10 is disposed close to the predetermined sound source S. For example, the predetermined sound source S includes a main valve connected to the steam turbine in the above-described power plant. In addition, for example, the sound source S includes an electric motor in the above-described mechanical plant. In the present embodiment, for example, the sound source S is supported by the floor surface F of the plant, and is disposed to protrude upward of the stand 10. That is, the stand 10 is installed to surround the sound source S. In this case, the stand 10 can be supplementarily installed for the sound source S.

For example, the stand 10 can be used as an inspection stand for inspecting the sound source S. The stand 10 has a top plate portion 11 and a leg portion 12. For example, the top plate portion 11 has a plate shape, and is provided parallel to the floor surface F. For example, an operator can pass through the top plate portion 11. FIG. 1 illustrates an example in which the top plate portion 11 has a rectangular shape, but the present invention is not limited thereto. In the present embodiment, the top plate portion 11 is in a state of being cut out or in an opened state so that the sound source S penetrates in an upward-downward direction. The leg portion 12 is disposed on the floor surface F to support the top plate portion 11.

In this plant, as illustrated in FIGS. 1 and 2, the antivibration sound insulation device 100 includes a sound insulation wall 20 and an antivibration mechanism 30. The antivibration mechanism 30 suppresses vibrations of the sound insulation wall 20. The antivibration mechanism 30 is attached to the stand 10 to support the sound insulation wall 20. For example, the antivibration mechanism 30 is fixed to the top plate portion 11, and is connected to each of a first wall portion 21, a second wall portion 22, and a third wall portion 23 (to be described later) of the sound insulation wall 20.

The sound insulation wall 20 is disposed to surround the sound source S. The sound insulation wall 20 causes a sound absorbing layer 28 installed on the sound source side to absorb and insulate the noise generated by the sound source S. In the present embodiment, the sound source S is disposed to protrude upward of the stand 10. Therefore, the sound insulation wall 20 is disposed in an upper portion of the stand 10. The sound insulation wall 20 has a first wall portion 21, a second wall portion 22, a third wall portion 23, and partial wall portions 24 and 25. For example, the first wall portion 21, the second wall portion 22, and the third wall portion 23 are rectangular flat plates. The first wall portion 21, the second wall portion 22, and the third wall portion 23 may have a curved shape. The first wall portion 21, the second wall portion 22, and the third wall portion are disposed in a U shape in a plan view to surround the sound source S.

The first wall portion 21 is disposed along a longitudinal direction of the top plate portion 11. The second wall portion 22 is connected to one end portion of the first wall portion 21 in the longitudinal direction of the top plate portion 11, and is disposed in a state of being orthogonal to the first wall portion 21. The second wall portion 22 is connected to the other end portion of the first wall portion 21 in the longitudinal direction of the top plate portion 11, and is disposed in a state of being orthogonal to the first wall portion 21.

The first wall portion 21, the second wall portion 22, and the third wall portion 23 respectively have sound absorbing layers 26, 27, and 28 on surfaces 21a, 22a, and 23a facing the sound source S. In the sound absorbing layers 26, 27, and 28, a sound absorbing material formed of a material such as polyurethane is formed in a sheet shape. The sound absorbing layers 26, 27, and 28 may be provided over entire surfaces of the first wall portion 21, the second wall portion 22, and the third wall portion 23, or may be partially provided.

The first wall portion 21, the second wall portion 22, and the third wall portion 23 are supported by the top plate portion 11 via the antivibration mechanism 30 (to be described later), thereby forming a gap with the top plate portion 11. The partial wall portions 24 and 25 are disposed to cover a portion of the gap. The partial wall portion 24 is disposed at a position which covers the gap formed between the second wall portion 22 and the top plate portion 11. The partial wall portion 25 is disposed at a position which covers the gap formed between the third wall portion 23 and the top plate portion 11. The partial wall portion may be disposed at a position which covers the gap formed between the first wall portion 21 and the top plate portion 11.

When the sound source S is inspected in the plant of the present embodiment, the operator moves on the top plate portion 11 of the stand 10. In the present embodiment, the antivibration sound insulation device 100 is provided for the sound source S. Therefore, the noise generated to the operator around the sound source S is reduced.

The antivibration sound insulation device 100 according to the present embodiment includes the antivibration mechanism 30 attached to the stand 10 disposed close to the predetermined sound source S in the plant, and the sound insulation wall 20 supported by the antivibration mechanism 30 and disposed to surround the sound source S. In the present embodiment, the antivibration mechanism 30 is attached to the top plate portion 11 of the stand 10.

Therefore, the antivibration mechanism 30 is attached to the top plate portion 11 of the stand 10, and the sound insulation wall 20 is supported by the antivibration mechanism 30. In this manner, the antivibration sound insulation device 100 can be supplementarily installed after the plant is constructed, and can be disposed at a place where the stand 10 is provided.

In the antivibration sound insulation device 100 according to the present embodiment, the sound insulation wall 20 has sound absorbing layers 26, 27, and 28 on surfaces facing the sound source S. Therefore, a sound pressure inside the sound insulation wall 20 can be reduced. In this manner, the sound pressure of the sound radiated outward from the sound insulation wall 20 can be reduced.

In the antivibration sound insulation device 100 according to the present embodiment, the sound source S is disposed to protrude upward of the stand 10, and the sound insulation wall 20 is disposed in the upper portion of the stand 10. Therefore, it is possible to reduce the noise generated to the operator who carries out inspection work or the like on the top plate portion 11 of the stand 10.

### Second Embodiment

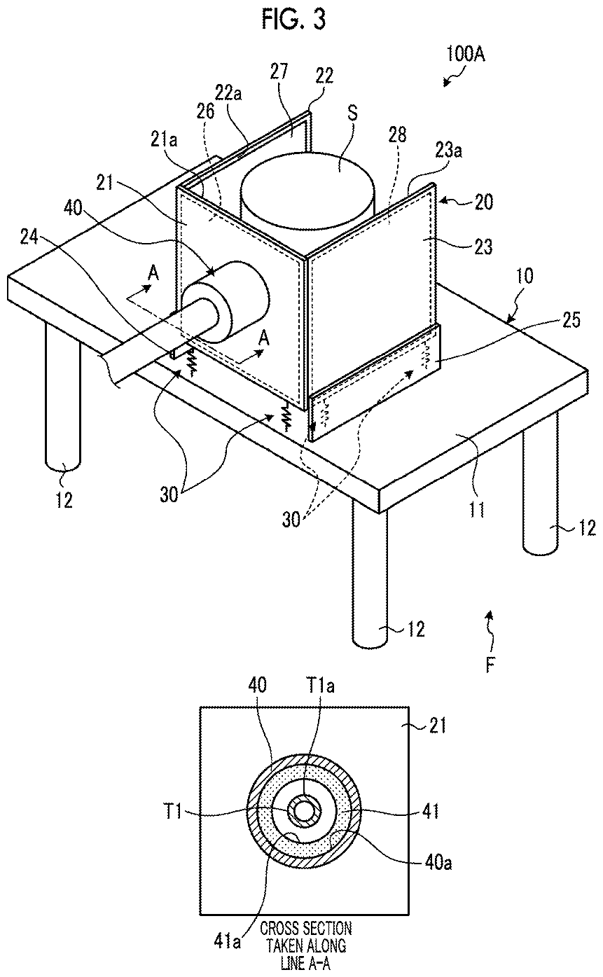

FIG. 3 is a view illustrating an example of an antivibration sound insulation device 100A according to a second embodiment. In addition, a cross section taken along line A-A is also illustrated in a portion in FIG. 3. As illustrated in FIG. 3, in the antivibration sound insulation device 100A, a duct 40 is provided in a portion of the sound insulation wall 20. Other configurations are the same as those in the first embodiment.

As illustrated in FIG. 3, the duct 40 is provided in the first wall portion 21 of the sound insulation wall 20. The duct 40 has a cylindrical shape, and protrudes to a side opposite to the sound source S side in the first wall portion 21. The duct 40 is disposed to surround a pipe T1 connected to the sound source S. The sound absorbing layer 41 is provided on an inner peripheral surface 40a of the duct 40. The sound absorbing layer 41 is provided over the entire inner peripheral surface 40a of the duct 40 in the circumferential direction of. The sound absorbing layer 41 may be provided in a portion of the inner peripheral surface 40a of the duct 40. The inner peripheral surface 40a of the duct 40 and an inner peripheral surface 41a of the sound absorbing layer 41 are disposed in a state of having an interval from an outer peripheral surface Tia of the pipe T1 on the entire surface in the circumferential direction. That is, the duct 40 and the sound absorbing layer 41 are disposed in a state where both of these are not in contact with the pipe T1. A tip portion of the duct 40 may be provided with a flange portion in a region covering the sound absorbing layer 41.

In the antivibration sound insulation device 100A according to the present embodiment, the sound insulation wall 20 has the duct 40 penetrating the sound source S side and a side opposite to the sound source S, and the sound absorbing layer 41 is provided on the inner peripheral surface 40a of the duct 40. Therefore, the sound passing through the inside of the duct 40 can be absorbed by the sound absorbing layer 41. In this manner, the sound pressure of the sound radiated outward of a portion surrounded by the sound insulation wall 20 can be reduced.

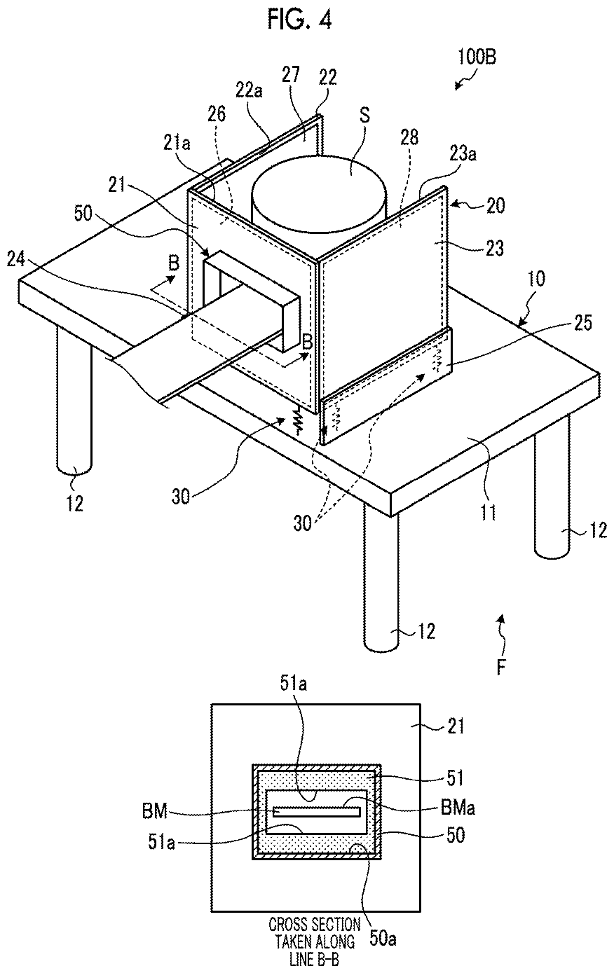

In the present embodiment, a case where the duct 40 has the cylindrical shape has been described as an example. However, the present invention is not limited thereto. FIG. 4 is a view illustrating an antivibration sound insulation device 100B according to a modification example. A cross section taken along line B-B is also illustrated in a portion in FIG. 4. The antivibration sound insulation device 100B illustrated in FIG. 4 has a configuration in which a rectangular duct 50 is provided on the first wall portion 21 of the sound insulation wall 20. The duct 50 is disposed to surround a beam portion BM protruding from the sound source S side.

A sound absorbing layer 51 is provided on an inner peripheral surface 50a of the duct 50. The sound absorbing layer 51 is provided over the entire inner peripheral surface 50a of the duct 50 in the circumferential direction. The sound absorbing layer 51 may be provided in a portion of the inner peripheral surface 50a of the duct 50. The inner peripheral surface 50a of the duct 50 and the inner peripheral surface 51a of the sound absorbing layer 51 are disposed in a state of having an interval from an outer peripheral surface BMa of the beam portion BM on the entire surface in the circumferential direction. That is, the duct 50 and the sound absorbing layer 51 are disposed in a state where both of these are not in contact with the beam portion BM. A tip portion of the duct 50 may be provided with a flange portion in a region covering the sound absorbing layer 51.

In this way, even when the rectangular duct 50 is provided, the sound passing through the inside of the duct 50 can be similarly absorbed by the sound absorbing layer 51. In this manner, the sound pressure of the sound radiated outward of a portion surrounded by the sound insulation wall 20 can be reduced.

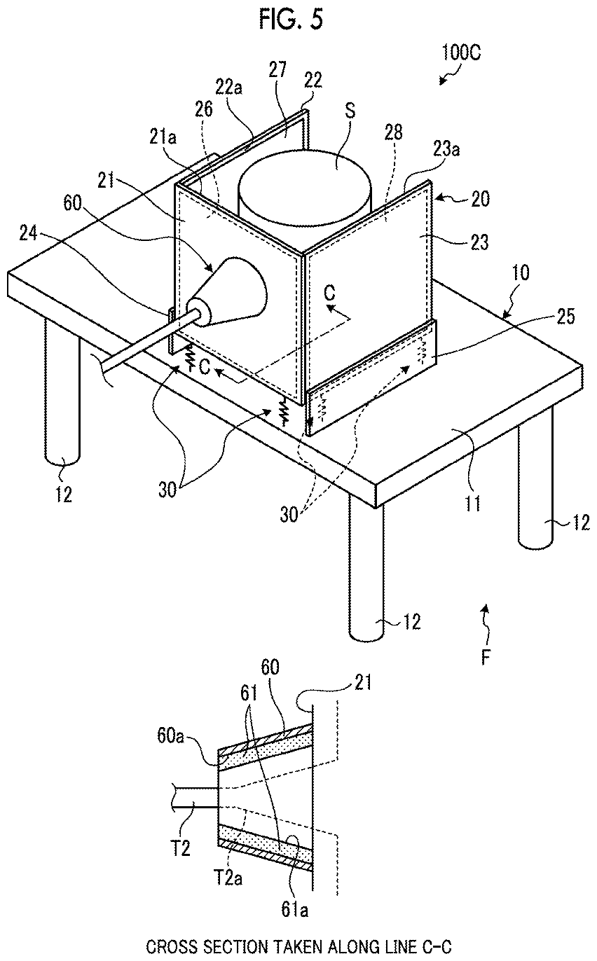

In addition, FIG. 5 is a view illustrating an antivibration sound insulation device 100C according to a modification example. A cross section taken along line C-C is also illustrated in a portion in FIG. 5. The antivibration sound insulation device 100C illustrated in FIG. 5 has a configuration in which a conical duct 60 is provided on the first wall portion 21 of the sound insulation wall 20. The duct 60 is disposed to surround a tapered pipe T2 protruding from the sound source S side.

A sound absorbing layer 61 is provided on an inner peripheral surface 60a of the duct 60. The sound absorbing layer 61 is provided over the entire inner peripheral surface 60a of the duct 60 in the circumferential direction. The sound absorbing layer 61 may be provided in a portion of the inner peripheral surface 60a of the duct 60. The inner peripheral surface 60a of the duct 60 and an inner peripheral surface 61a of the sound absorbing layer 61 are disposed in a state of having an interval from an outer peripheral surface T2a of the pipe T2 on the entire surface in the circumferential direction. That is, the duct 60 and the sound absorbing layer 61 are disposed in a state where both of these are not in contact with the pipe T2. A tip portion of the duct 60 may be provided with a flange portion in a region covering the sound absorbing layer 61.

In this way, even when the conical duct 60 is provided, the sound passing through the inside of the duct 60 can be similarly absorbed by the sound absorbing layer 61. In this manner, the sound pressure of the sound radiated outward of a portion surrounded by the sound insulation wall 20 can be reduced.

### Third Embodiment

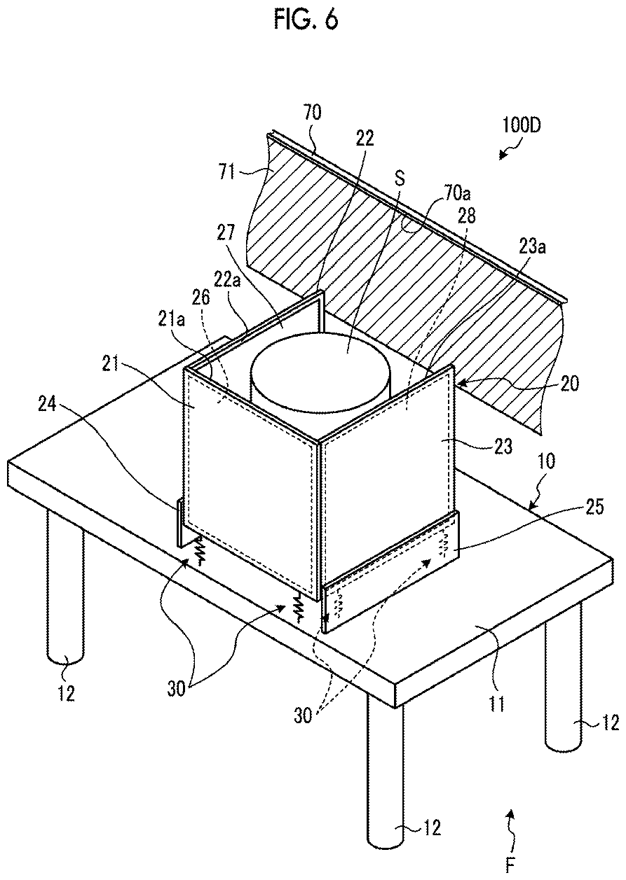

FIG. 6 is a view illustrating an example of an antivibration sound insulation device 100D according to a third embodiment. As illustrated in FIG. 6, the antivibration sound insulation device 100D is configured as follows. The sound insulation wall 20 is disposed to open a portion of the sound source S in the circumferential direction, and a sound absorbing member 70 is disposed at a position corresponding to an open portion of the sound insulation wall 20. Other configurations are the same as those in the first embodiment.

For example, as the sound absorbing member 70, a plate-shaped member can be used. The sound absorbing member 70 is supported by the stand 10 or the floor surface F. In the sound absorbing member 70, a sound absorbing layer 171 using a resin material such as polyurethane is disposed on a facing surface 70a facing the sound source S. The sound absorbing member 70 may be configured by partially using other configurations inside the plant.

In this way, in the antivibration sound insulation device 100D according to the present embodiment, the sound insulation wall 20 further includes the sound absorbing member 70 disposed to open a portion of the sound source S in the circumferential direction, and disposed at a position corresponding to an open portion of the sound insulation wall 20. Therefore, the sound pressure of the sound radiated from the open portion of the sound insulation wall 20 can be reduced.

### Fourth Embodiment

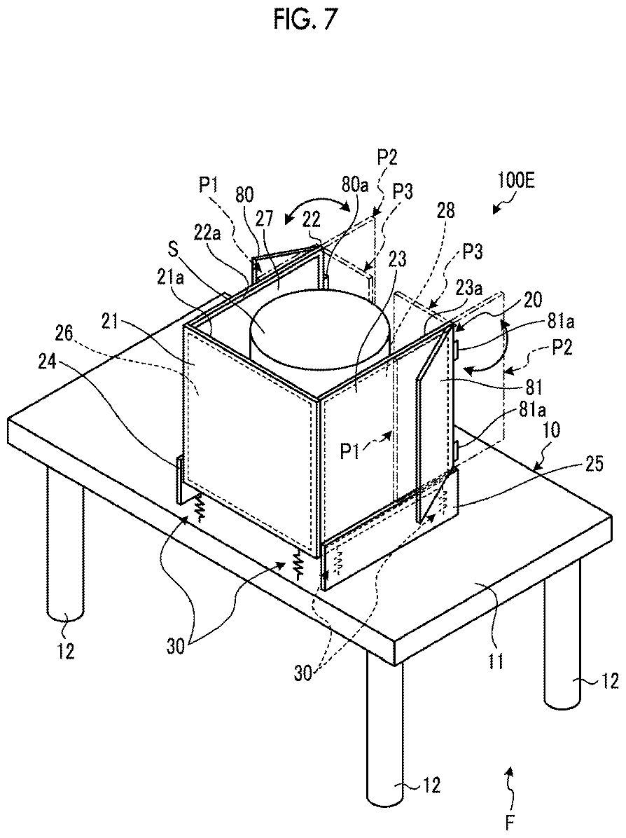

FIG. 7 is a view illustrating an example of an antivibration sound insulation device 100E according to a fourth embodiment. As illustrated in FIG. 7, the antivibration sound insulation device 100E is disposed so that a portion of the sound insulation wall 20 is pivotable around a predetermined axis. Specifically, the sound insulation wall 20 has pivoting portions 80 and 81. For example, the pivoting portion 80 is attached to the second wall portion 22 via a hinge portion (shaft) 80a. For example, the pivoting portion 81 is attached to the third wall portion 23 via a hinge portion (shaft) 81a.

The pivoting portions 80 and 81 are pivotable around the hinge portions 80a and 81a among an accommodation position P1, an extension position P2, and a closing position P3. Since the pivoting portions 80 and 81 are disposed at the accommodation position P1, the sound insulation wall 20 has a compact configuration. Therefore, a burden on the operator in installation work when installing the sound insulation wall 20 is reduced. In addition, since the pivoting portions 80 and 81 are disposed at the extension position P2, widths of the second wall portion 22 and the third wall portion 23 can be widened. In addition, since the pivoting portions 80 and 81 are disposed at the closing position P3, the open portion of the sound insulation wall 20 can be opened and closed. The pivoting portions 80 and 81 may be provided with the sound absorbing layer in a portion facing the sound source S at the closing position P3. Since the positions of the pivoting portions 80 and 81 are disposed at the extension position P2 and the closing position P3, the noise leaking from the sound insulation wall 20 can be easily adjusted in a work site.

In the antivibration sound insulation device 100E according to the present embodiment, the sound insulation wall 20 is provided so that the pivoting portions 80 and 81 are pivotable around the hinge portions 80a and 81a. Therefore, depending on the positions where the pivoting portions 80 and 81 are disposed, the burden in the installation work of the sound insulation wall 20 can be reduced, and the noise leaking from the sound insulation wall 20 can be easily adjusted in the work site.

### Fifth Embodiment

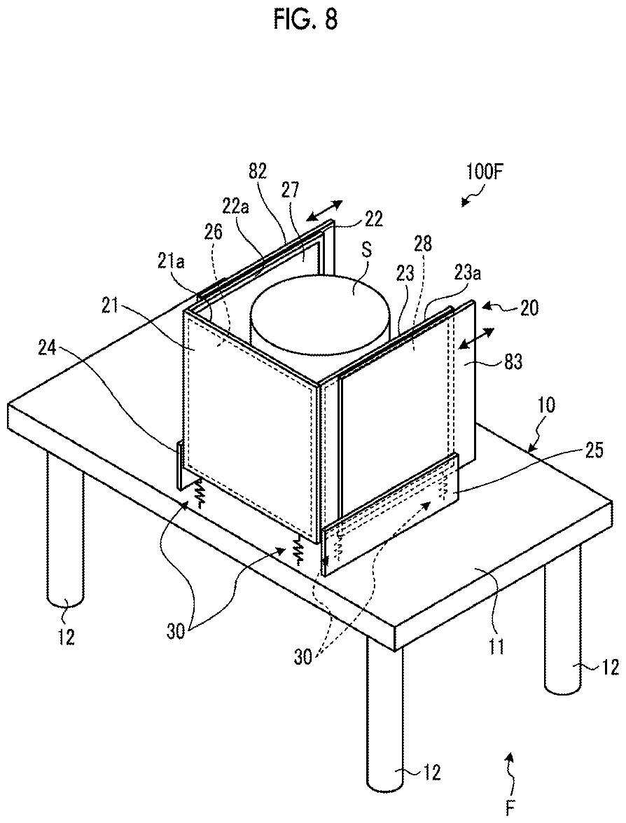

FIG. 8 is a view illustrating an example of an antivibration sound insulation device 100F according to a fifth embodiment. As illustrated in FIG. 8, the antivibration sound insulation device 100F is provided so that a portion of the sound insulation wall 20 is slidable. Specifically, the sound insulation wall 20 has slide portions 82 and 83. The slide portion 82 is slidable in a horizontal direction along the second wall portion 22. The slide portion 83 is slidable in the horizontal direction along the third wall portion 23. Since the slide portions 82 and 83 are slid in the horizontal direction along the second wall portion 22 and the third wall portion 23, the widths of the second wall portion 22 and the third wall portion 23 can be widened. The slide portions 82 and 83 may be provided with the sound absorbing layer formed of a material such as polyurethane on surfaces on the sound source S side.

In the antivibration sound insulation device 100F according to the present embodiment, a portion of the sound insulation wall 20 is provided to be slidable in the horizontal direction by the slide portions 82 and 83. Therefore, the widths of the second wall portion 22 and the third wall portion 23 can be easily widened. In this manner, the noise leaking from the sound insulation wall 20 can be easily adjusted in the work site.

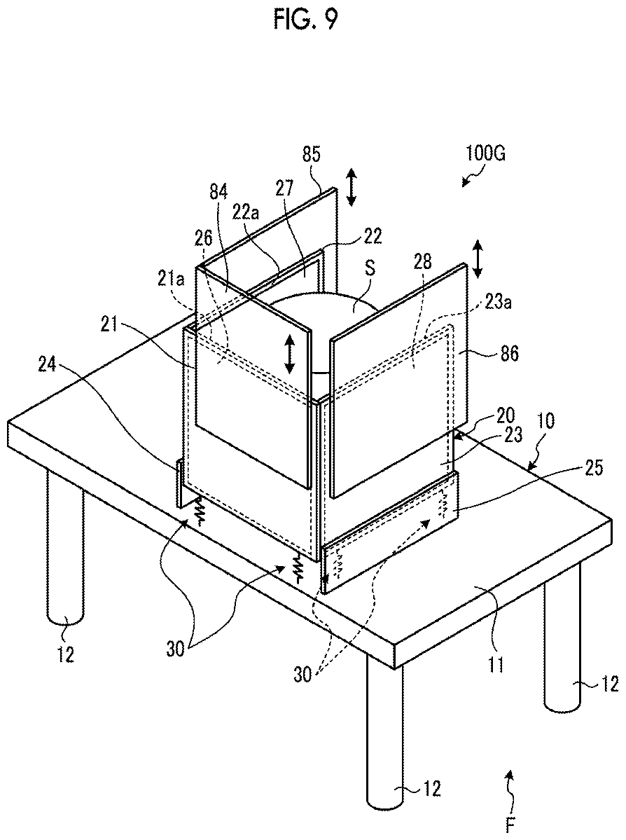

FIG. 9 is a view illustrating an antivibration sound insulation device 100G according to a modification example. As illustrated in FIG. 9, in the antivibration sound insulation device 100G, a portion of the sound insulation wall 20 is provided to be slidable in the upward-downward direction. Specifically, the sound insulation wall 20 has slide portions 84, 85, and 86. The slide portion 84 is slidable in the upward-downward direction along the first wall portion 21. The slide portion 85 is slidable in the upward-downward direction along the second wall portion 22. The slide portion 86 is slidable in the upward-downward direction along the third wall portion 23. The slide portions 84, 85, and 86 may be provided with the sound absorbing layer formed of a material such as polyurethane on surfaces on the sound source S side.

In the antivibration sound insulation device 100G, a portion of the sound insulation wall 20 is provided to be slidable in the upward-downward direction by the slide portions 84, 85, and 86. Therefore, the noise leaking from the sound insulation wall 20 can be easily adjusted in the work site.

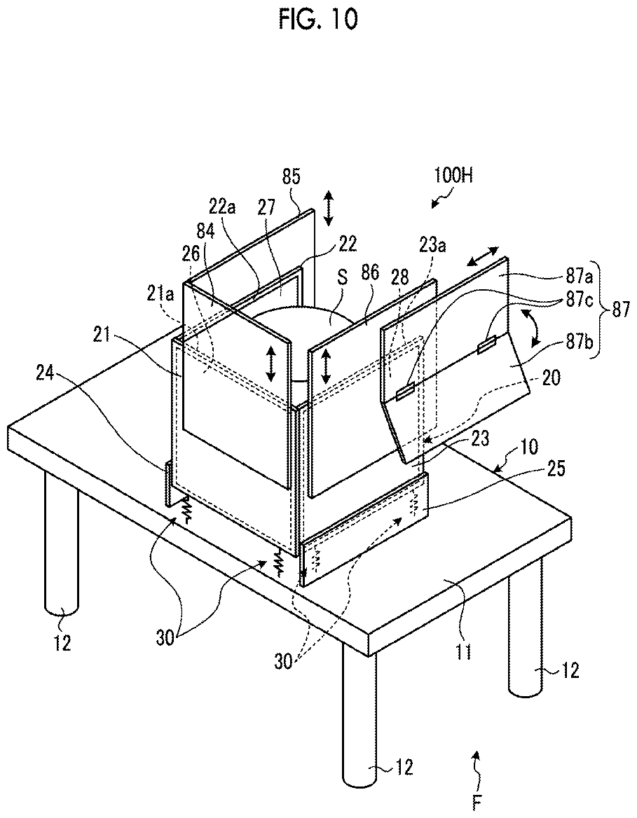

FIG. 10 is a view illustrating an antivibration sound insulation device 100H according to a modification example. As illustrated in FIG. 10, in the antivibration sound insulation device 100H, a portion of the sound insulation wall 20 is provided to be slidable in the upward-downward direction and the horizontal direction, and a portion of the sound insulation wall 20 is pivotable around a predetermined axis. Specifically, the sound insulation wall 20 has the slide portions 84, 85, and 86, as in the configuration illustrated in FIG. 9. In addition, the sound insulation wall 20 has a slide pivoting portion 87. The slide pivoting portion 87 has a slide portion 87a and a pivoting portion 87b. The slide portion 87a is slidable in the horizontal direction along the slide portion 86. The pivoting portion 87b is pivotable around a hinge portion (shaft) 87c. The slide portion 85 may be provided with a configuration the same as that of the slide pivoting portion 87.

In the antivibration sound insulation device 100H, a portion of the sound insulation wall 20 is provided to be slidable in the upward-downward direction by the slide portions 84, 85, and 86, and a portion of the sound insulation wall 20 is provided to be slidable in the horizontal direction by the slide portion 87a. Therefore, the noise leaking from the sound insulation wall 20 can be easily adjusted in the work site. In addition, a portion of the sound insulation wall 20 is provided to be pivotable around the hinge portion 87c by the pivoting portion 87b. Therefore, depending on the position where the pivoting portion 87b is disposed, the burden in the installation work of the sound insulation wall 20 can be reduced, and the noise leaking from the sound insulation wall 20 can be easily adjusted in the work site.

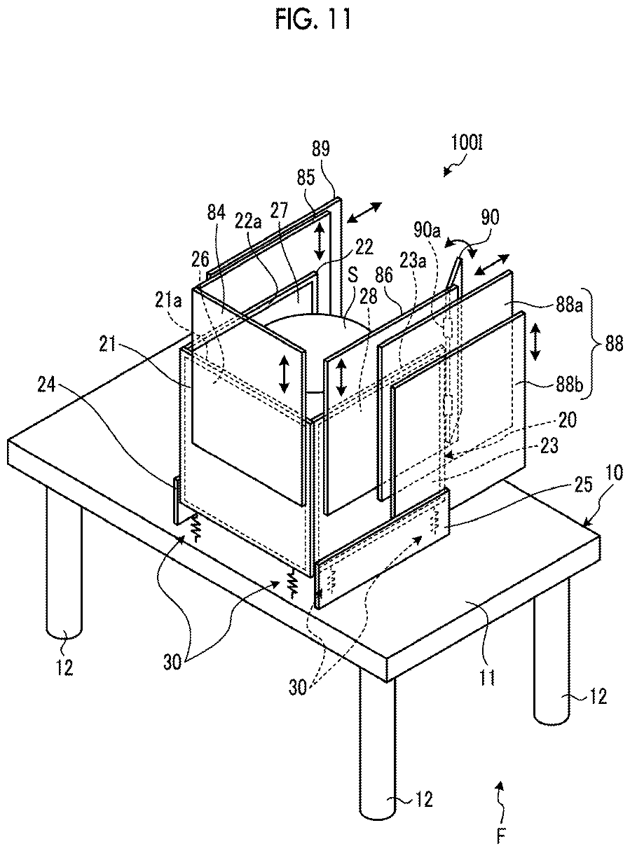

FIG. 11 is a view illustrating an antivibration sound insulation device 100I according to a modification example. As illustrated in FIG. 11, in the antivibration sound insulation device 100I, a portion of the sound insulation wall 20 is provided to be slidable in the upward-downward direction and the horizontal direction, and a portion of the sound insulation wall 20 is pivotable around a predetermined axis. Specifically, the sound insulation wall 20 has the slide portions 84, 85, and 86, as in the configuration illustrated in FIG. 9. In addition, the sound insulation wall 20 has slide portions 88 and 89. The slide portion 88 has a first slide portion 88a and a second slide portion 88b. The first slide portion 88a is slidable in the horizontal direction along the slide portion 86. The second slide portion 88b is slidable in the upward-downward direction along the first slide portion 88a. The slide portion 89 is slidable in the horizontal direction along the slide portion 85. The slide portion 89 may have a configuration the same as that of the slide portion 88. In addition, the sound insulation wall 20 has a pivoting portion 90. The pivoting portion 90 is pivotable around a hinge portion 90a in an opening and closing direction of the sound insulation wall 20.

In the antivibration sound insulation device 100I, a portion of the sound insulation wall 20 is provided to be slidable in the upward-downward direction by the slide portions 84, 85, and 86 and the second slide portion 88b, and a portion is provided to be slidable in the horizontal direction by the first slide portion 88a and the slide portion 89. Therefore, the noise leaking from the sound insulation wall 20 can be easily adjusted in the work site. In addition, a portion of the sound insulation wall 20 is provided to be pivotable around the hinge portion 90a by the pivoting portion 90. Therefore, depending on the position where the pivoting portion 90 is disposed, the burden in the installation work of the sound insulation wall 20 can be reduced, and the noise leaking from the sound insulation wall 20 can be easily adjusted in the work site.

### Sixth Embodiment

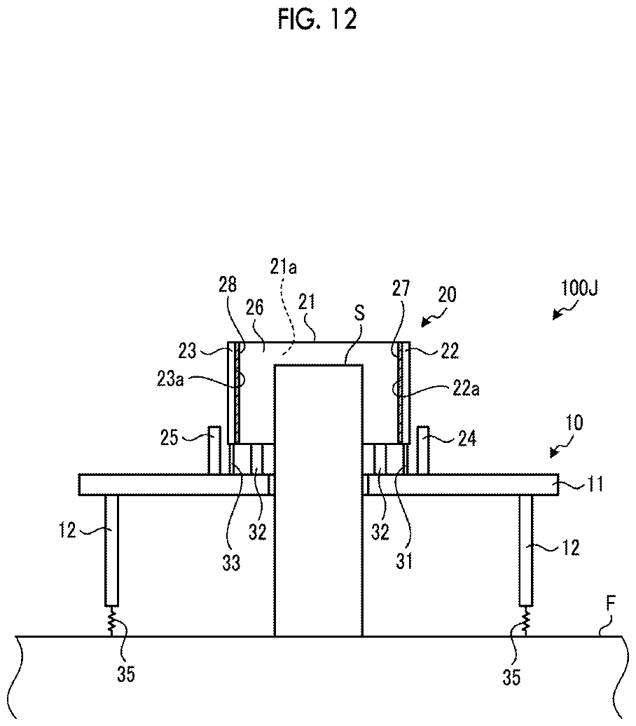

FIG. 12 is a view illustrating an antivibration sound insulation device 100J according to a sixth embodiment. As illustrated in FIG. 12, the antivibration sound insulation device 100J is provided with a stand antivibration mechanism 35 disposed on the floor surface F to support the stand 10, and the sound insulation wall 20 is integrally supported by the stand 10. Specifically, for example, in the sound insulation wall 20, the first wall portion 21, the second wall portion 22, and the third wall portion 23 are integrally supported in the top plate portion 11 of the stand 10 by each of the support members 31, 32, and 33. In addition, in the stand 10, the leg portion 12 is supported by the floor surface F via the stand antivibration mechanism 35. The stand antivibration mechanism 35 can be supplementarily installed for the stand 10 after being installed on the floor surface F of the plant. The configuration of the stand antivibration mechanism 35 can be the same as the configuration of the antivibration mechanism 30 in the above-described embodiment.

The antivibration sound insulation device 100J according to the present embodiment includes the stand antivibration mechanism (antivibration mechanism) 35 attached to the stand 10 disposed close to the predetermined sound source S in the plant, and the sound insulation wall 20 supported by the stand antivibration mechanism 35 and disposed to surround the sound source S. In the present embodiment, the stand antivibration mechanism 35 is disposed on the floor surface F of the plant to support the stand 10. The sound insulation wall 20 is integrally attached to the stand 10, and is supported by the stand antivibration mechanism 35 via the stand 10. At least a portion of the stand 10 forms a portion of the sound insulation wall 20.

Therefore, the stand antivibration mechanism 35 is attached between the stand 10 and the floor surface F, and the sound insulation wall 20 is supported by the stand 10. In this manner, the antivibration sound insulation device 100J can be supplementarily installed after the plant is constructed, and can be disposed for a place where the stand 10 is provided. In addition, at least a portion of the stand 10 (for example, the top plate portion 11) can be used as a portion of the sound insulation wall 20. Therefore, a sound insulation effect can be improved.

The technical scope of the present invention is not limited to the above-described embodiments, and modifications can be appropriately added within the scope not departing from the concept of the present invention. For example, in the above-described embodiments, a configuration in which the sound source S is disposed to protrude upward of the stand 10 and the sound insulation wall 20 is disposed in the upper portion of the stand 10 has been described as an example. However, the present invention is not limited thereto.

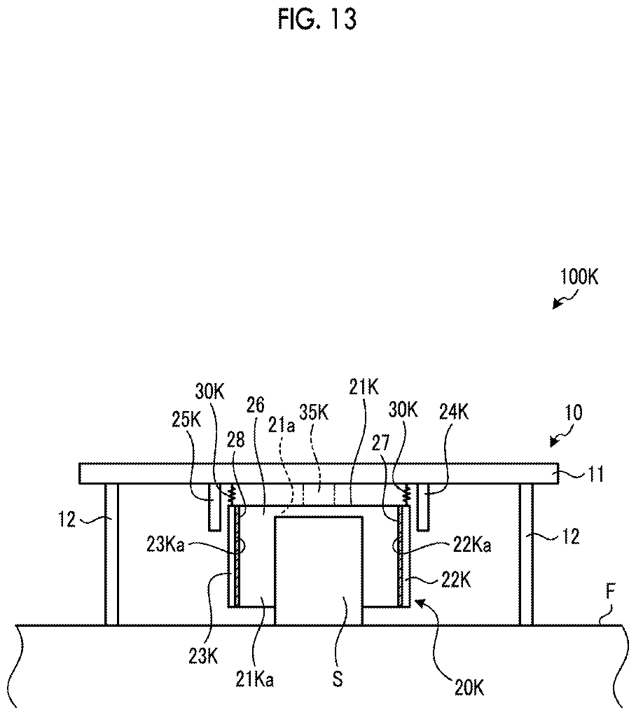

FIG. 13 is a view illustrating an antivibration sound insulation device 100K according to a modification example. As illustrated in FIG. 13, the antivibration sound insulation device 100K is configured as follows. The sound source S is disposed below the top plate portion 11 of the stand 10, and the sound insulation wall 20K is disposed in a lower portion of the top plate portion 11 of the stand 10. The sound insulation wall 20K has a first wall portion 21K, a second wall portion 22K, and a third wall portion 23K. The sound insulation wall 20K is supported by the top plate portion 11 via an antivibration mechanism 30K. The antivibration mechanism 30K is attached to a lower surface of the top plate portion 11. Partial sound insulation walls 24K and 25K are provided between the sound insulation wall 20K and the top plate portion 11.

According to this configuration, since the stand 10 is used, the noise from the sound source S disposed below the top plate portion 11 of the stand 10 can be reduced. In this case, the noise generated to the operator around the sound source S can be efficiently reduced on the floor surface F of the plant.

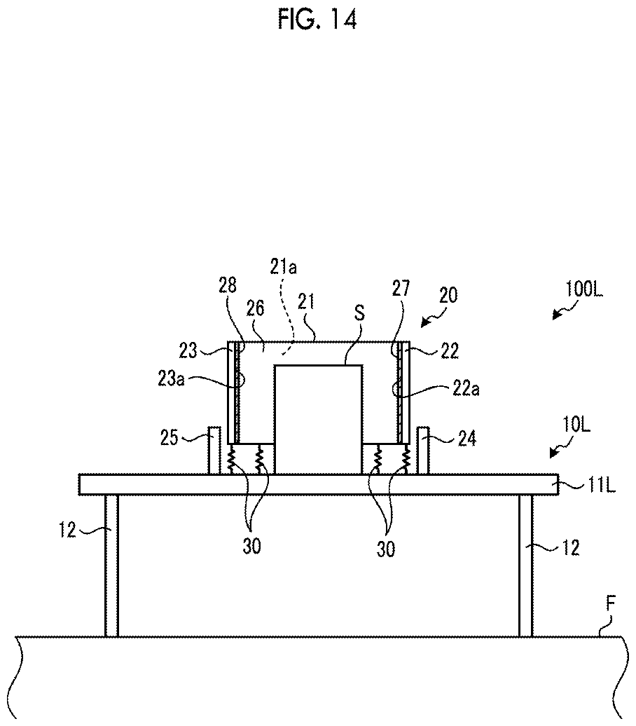

In addition, in the above-described embodiments, a configuration in which the sound source S is supported by the floor surface F of the plant has been described as an example. However, the present invention is not limited thereto. FIG. 14 is a view illustrating an antivibration sound insulation device 100L according to a modification example. As illustrated in FIG. 14, in the antivibration sound insulation device 100L, the sound source S is supported on a top plate portion 11L of a stand 10L. In this way, even according to a configuration in which the sound source S is supported by the top plate portion 11L of the stand 10L, the noise generated to the operator around the sound source S can be efficiently reduced.

### REFERENCE SIGNS LIST

10, 10L: Stand
11, 11L: Top plate portion
12: Leg portion
20, 20K: Sound insulation wall
21, 21K: First wall portion
21a, 22a, 23a: Surface
22, 22K: Second wall portion
23, 23K: Third wall portion
24, 25: Partial wall portion
24K, 25K: Partial sound insulation wall
26, 27, 28, 41, 51, 61: Sound absorbing layer
30, 30K: Antivibration mechanism
31, 32, 33: Support member
35: Stand antivibration mechanism, stand antivibration mechanism
40, 50, 60: Duct
40a, 41a, 50a, 51a, 60a, 61a: Inner peripheral surface
70: Sound absorbing member
70a: Facing surface
71: Sound absorbing layer
80, 81, 87b, 90: Pivoting portion
80a, 81a, 87c, 90a: Hinge portion
82, 83, 84, 85, 86, 87a, 88, 89: Slide portion
87: Slide pivoting portion
88a: First slide portion
88b: Second slide portion
100, 100A, 100B, 100C, 100D, 100E, 100F, 100G, 100H, 100I, 100J, 100K, 100L: Antivibration sound insulation device
BM: Beam portion
F: Floor surface
P1: Accommodation position
P2: Extension position
P3: Closing position
S: Sound source
T1, T2: Pipe
T1a, T2a, BMa: Outer peripheral surface

What is claimed is:

1. An antivibration sound insulation device comprising:
an antivibration mechanism attached to a stand disposed close to a predetermined sound source at a plant; and
a sound absorbing sound insulation wall supported by the antivibration mechanism and disposed to surround the sound source.

2. The antivibration sound insulation device according to claim 1,
wherein the antivibration mechanism is attached to a top plate portion of the stand.

3. The antivibration sound insulation device according to claim 1,
wherein the antivibration mechanism is disposed on a floor surface of the plant to support the stand,
the sound insulation wall is integrally attached to the stand, and is supported by the antivibration mechanism via the stand, and
at least a portion of the stand forms a portion of the sound insulation wall.

4. The antivibration sound insulation device according to claim 1,
wherein the sound insulation wall has a sound absorbing layer on a surface facing the sound source.

5. The antivibration sound insulation device according to claim 1,
wherein the sound source is disposed to protrude upward of the stand, and
the sound insulation wall is disposed in an upper portion of the stand.

6. The antivibration sound insulation device according to claim 1,
wherein the sound insulation wall has a duct penetrating the sound source side and a side opposite to the sound source, and
a sound absorbing layer is provided on an inner surface of the duct.

7. The antivibration sound insulation device according to claim 1,
wherein the sound insulation wall is disposed to open a portion of the sound source in a circumferential direction, and further includes a sound absorbing member disposed at a position corresponding to an open portion of the sound insulation wall.

8. The antivibration sound insulation device according to claim 1,
wherein a portion of the sound insulation wall is provided to be pivotable around a predetermined axis.

9. The antivibration sound insulation device according to claim 1,
wherein a portion of the sound insulation wall is provided to be slidable.
